(19) United States
(12) Patent Application Publication
(10) Pub. No.: US 2008/0287200 A1
(43) Pub. Date: Nov. 20, 2008

(54) GAMING TABLE

(75) Inventor: Arden Yang, Rosemead, CA (US)

Correspondence Address: BUTZEL LONG;IP DOCKETING DEPT, 350 SOUTH MAIN STREET, SUITE 300, ANN ARBOR, MI, 48104, US

(73) Assignee: ASTRO CORPORATION, Arden Yang - President, Taipei (TW)

(21) Appl. No.: 12/118,214

(22) Filed: May 9, 2008

(30) Foreign Application Priority Data
May 16, 2007 (TW) 096207900

(51) Int. Cl. A63F 13/08

(52) U.S. Cl. 463/46; 273/309

(57) ABSTRACT

A gaming table includes a table body, a display device, and a positioning unit. The display device is mounted pivotably to the table body, is pivotable relative to the table body between at least one viewing position and a storage position, and is operable to display a gaming screen thereon. The positioning unit is for positioning releasably the display device at the viewing position relative to the table body.

### CROSS-REFERENCE TO RELATED APPLICATION

This application claims priority of Taiwanese application no. 096207900, filed on May 16, 2007.

### BACKGROUND OF THE INVENTION

1. Field of the Invention

This invention relates to a gaming table, more particularly to a gaming table having a positionable display device.

2. Description of the Related Art

Referring to FIG. 1, WO 2005/043475 A1 discloses a gaming table 4 for electronic gaming that is suitable for two or more players. The gaming table 4 includes a plurality of personal display units 40 operable to display gaming information for viewing by an individual player, such as the player hand status, and a display device 41 operable to display gaming information for 1 viewing by all of the players, such as a dealer hand status. Since the display device 41 is inset in the gaming table 4, the gaming information displayed thereon is not clearly and easily visible to everyone of the players, which compromises the fairness of the game and the overall quality of the gaming experience. Therefore, there is a need to improve the visibility of the information displayed on the display device 41.

### SUMMARY OF THE INVENTION

Therefore, an object of the present invention is to provide a gaming table that is capable of overcoming the aforementioned drawbacks of the prior art.

According to the present invention, there is provided a gaming table comprising a table body, a display device, and a positioning unit.

The display device is mounted pivotably to the table body, is pivotable relative to the table body between at least one viewing position and a storage position, and is operable to display a gaming screen thereon. The positioning unit is for positioning releasably the display device at the viewing position relative to the table body.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a gaming table disclosed in WO 2005/043475 A1;

FIG. 2 is a partly exploded, perspective view of a first preferred embodiment of a gaming table according to the present invention;

FIG. 3 is a schematic partly sectional view of the gaming table of FIG. 2, illustrating a display device at a viewing position;

FIG. 4 is a view similar to FIG. 3, but illustrating the display device at a storage position;

FIG. 5 is a schematic partly sectional view of a second preferred embodiment of a gaming table according to the present invention, illustrating a display device at a viewing position;

FIG. 6 is a view similar to FIG. 5, but illustrating the display device at a storage position;

FIG. 7 is a schematic partly sectional view of a third preferred embodiment of a gaming table according to the present invention, illustrating display devices at viewing positions; and

FIG. 8 is a view similar to FIG. 7, but illustrating the display devices at storage positions.

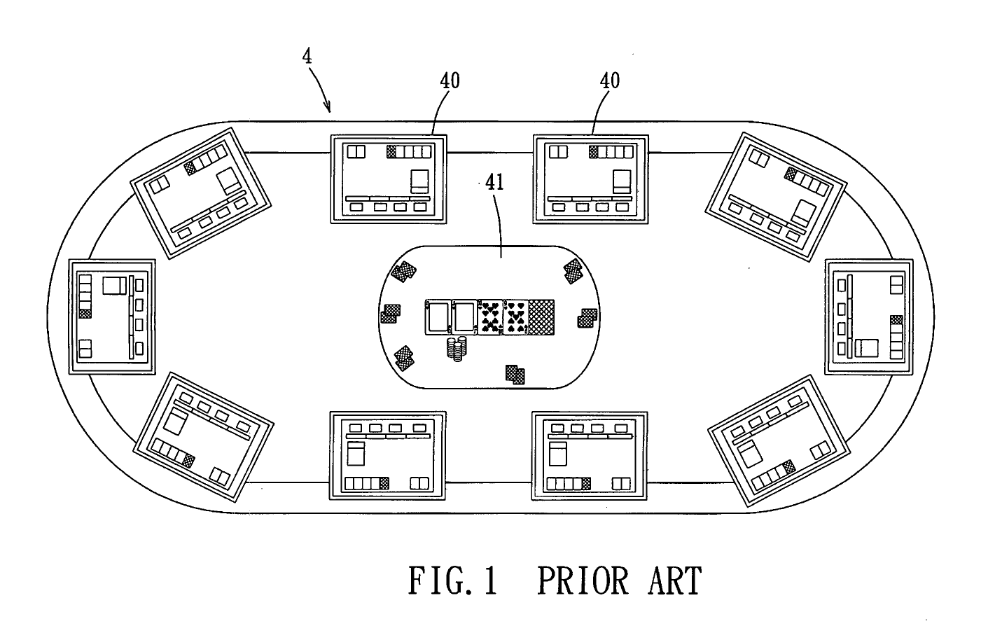

### DETAILED DESCRIPTION OF THE PREFERRED EMBODIMENTS

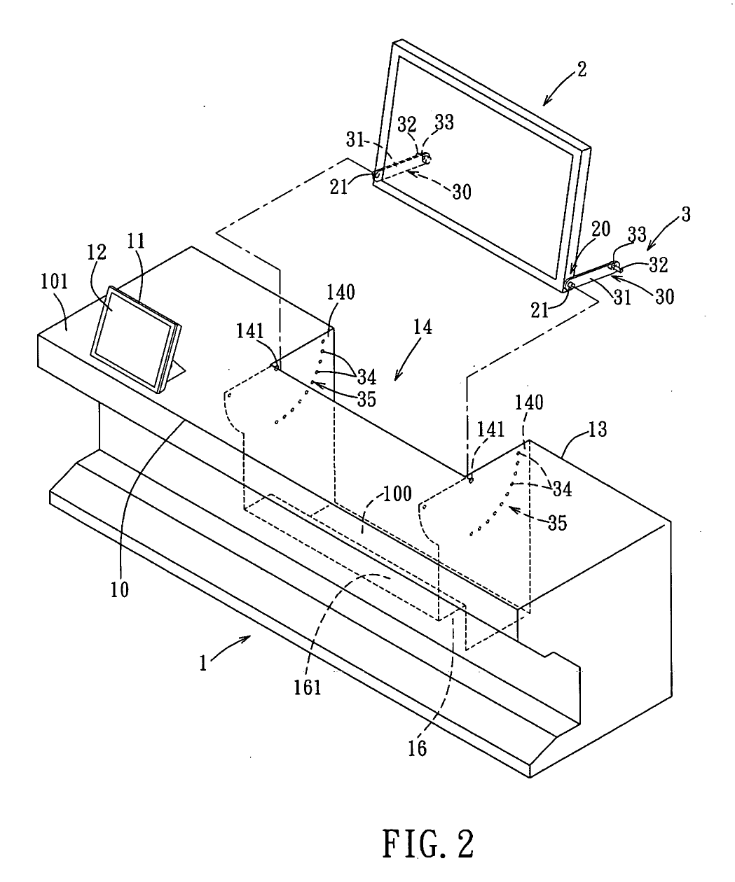

FIG. 2 illustrates a first preferred embodiment of a gaming table according to the present invention. The gaming table comprises a table body 1, a display device 2, and a positioning unit 3.

The display device 2 is mounted pivotably to the table body 1, is pivotable relative to the table body 1 between at least one viewing position and a storage position, and is operable to display a gaming screen thereon. The positioning unit 3 is for positioning releasably the display device 2 at the viewing position relative to the table body 1.

In this embodiment, the table body 1 has an elongate form, and includes a leg portion and a table top 101. The table top 101 is disposed on the leg portion and has a longitudinal edge 10. A personal display unit 11 is disposed on the table top 101 adjacent to the longitudinal edge 10 for viewing by an individual player. In this embodiment, the personal display unit 11 is smaller than the display device 2 and has a screen 12 that is positionable for achieving a desired viewing position.

Preferably, the table body 1 is formed with a recess 14 that is located in an intermediate section of another longitudinal edge 13 of the table top 101 and that extends into the leg portion. The leg portion has a pair of opposing inner walls 140 which define opposite sides of the recess 14 and which have upper portions formed with aligned pivot holes 141, respectively. Preferably, the upper portion of at least one of the inner walls 140 is formed with a plurality of positioning holes 34 arranged in an arc 35 that has a curvature center at the pivot hole 141. In this embodiment, the upper portion of each of the inner walls 140 is formed with the positioning holes 34.

In this embodiment, the leg portion of the table body 1 has a raised stop platform 16 that extends upwardly and that is disposed adjacent to a bottom part 100 of the recess 14. A distance between a top surface 161 of the stop platform 16 and a table surface of the table top 101 is slightly smaller than a height of the display device 2.

In this embodiment, the display device 2 is an LCD monitor that has opposite side edges, each of which has a lower portion 20 provided with a pivot shaft 21 for engaging pivotably the pivot hole 141 in an adjacent one of the inner walls 140 of the leg portion of the table body 1. Each pivot hole 141 acts as a fulcrum on which the display device 2 is pivotable.

Preferably, the positioning unit 3 includes at least one positioning implement 30 between the display device 2 and the table body 1. The positioning implement 30 includes a positioning arm 31 that has a mounting end mounted to the display device 2 and a positioning end formed with a fastener hole 33. The positioning arm 31 is movable with the display device 2 to align the fastener hole 33 with a selected one of the positioning holes 34 in the table body 1. The positioning implement 30 further includes a fastening component 32 that extends removably through the fastener hole 33 and into the selected one of the positioning holes 34 to position the display device 2 at the viewing position.

In this embodiment, the positioning unit 3 includes two of the positioning implements 30, though in practice, just one of the positioning implements 30 is sufficient to position the display device 2. Each of the positioning arms 31 is mounted to the lower portion 20 of one of the opposite side edges of the display device 2 and extends rearwardly therefrom, such that when the positioning arms 31 are substantially parallel to the table top 1, the display device 2 is at an optimum one of the viewing positions. Alternatively, the positioning arm 31 may extend rearwardly from a bottom edge of a lower portion of the display device 2. In this embodiment, the fastening component 32 is a pin.

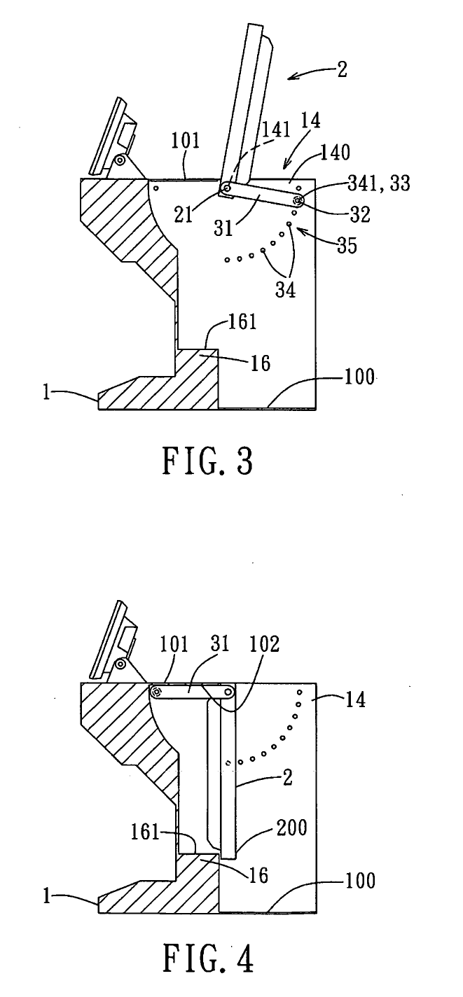

Referring to FIG. 3, to position the display device 2 of the first preferred embodiment at the optimum one of the viewing positions, the positioning arms 31 are first moved with the display device 2 to align each of the fastener holes 33 with a second highest one 341 of the positioning holes 34 in the adjacent inner wall 140. Then, each of the fastening components 32 is extended removably through a respective one of the fastener holes 33 and into the selected second highest one 341 of the is positioning holes 34 to position the display device 2 at the optimal viewing position. As previously mentioned, when the display device 2 is at the optimum one of the viewing positions, the positioning arms 31 are substantially parallel to the table top 101.

In this embodiment, when it is desired to store the display device 2, the fastening components 32 are removed and the positioning arms 31 are then moved downward with the display device 2 until the display device 2 extends downwardly into the recess 14 such that a top portion 200 of the display device 2 is stopped by the stop platform 16 of the leg portion, as best shown in FIG. 4. In the above described storage position of the display device 2, the positioning arms 31 are parallel to the table top 101 and abut against a bottom surface 102 of the table top 101.

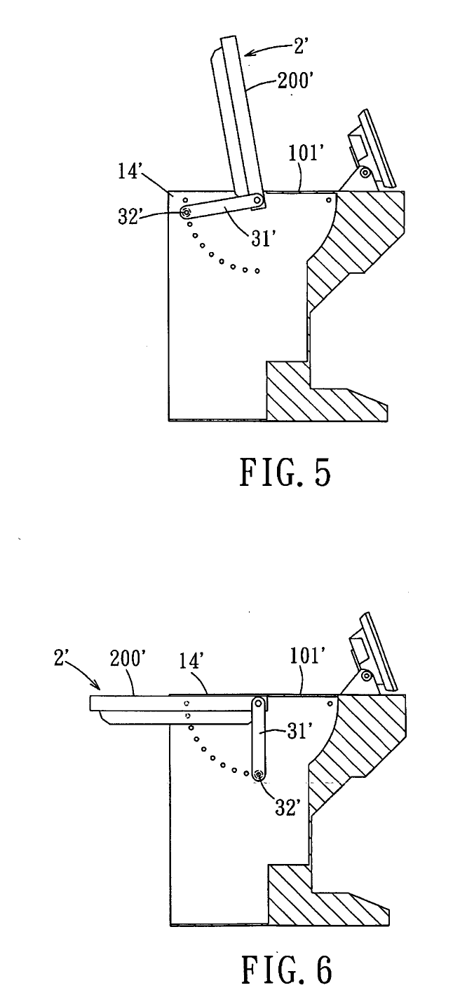

FIG. 5 illustrates a second preferred embodiment of this invention, which differs from the first preferred embodiment in the manner in which the display device 2′ is positioned for storage. In this embodiment, when it is desired to store the display device 2′, the fastening components 32′ are removed, and the positioning arms 31′ are then moved downward with the display device 2′ until the display device 2′ extends into the recess 14′ and the screen 200′ of the display device 2′ is flush with the table top 101′, as best shown in FIG. 6. In the above described storage position of the display device 2′, the positioning arms 31′ are perpendicular to the table top 101′.

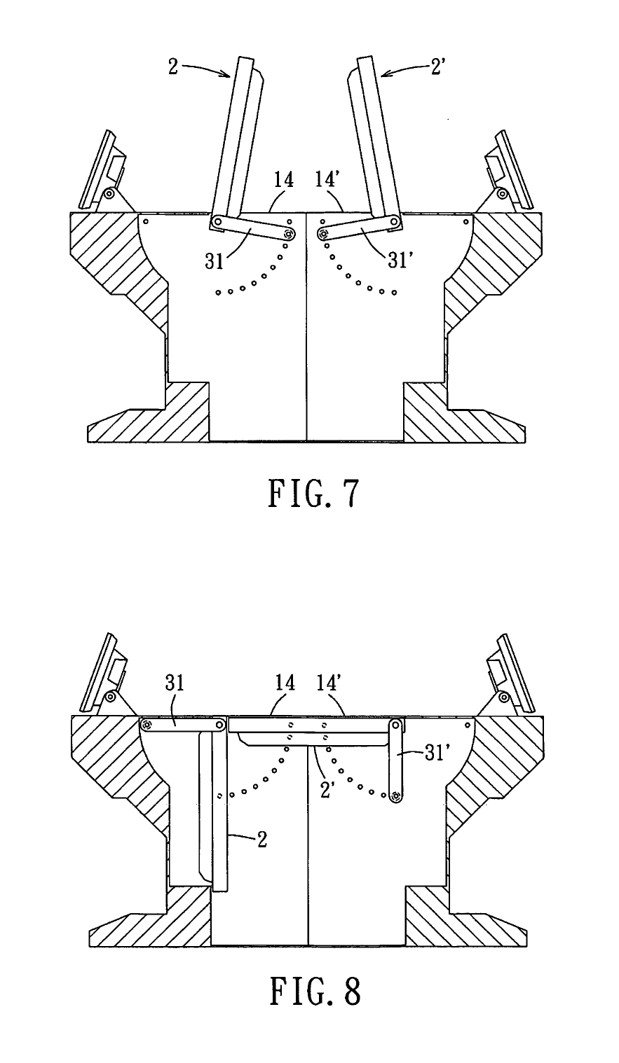

In a third preferred embodiment of this invention, the gaming table of FIG. 3 and the gaming table of FIG. 5 are joined together. When it is desired to dispose the display devices 2,2′ of the gaming tables at viewing positions, each of the display devices 2,2′ is first positioned for viewing as shown in FIGS. 3 and 5, respectively, and the gaming tables are then joined as shown in FIG. 7. When it is desired to dispose the display devices 2,2′ of the gaming tables at storage positions, each of the display devices 2,2′ is first positioned for storage as shown in FIGS. 4 and 6, respectively, and the gaming tables are then joined in such a way that the display device 2′ of the gaming table of FIG. 6 extends into the recess 14 of the gaming table of FIG. 4, so that the recesses 14, 14′ of the gaming tables are hidden as shown in FIG. 8.

It has thus been shown that the gaming table of the present invention provides a display device that permits players to view gaming information clearly and easily, and that can be stored.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A gaming table comprising:
a table body;
a display device mounted pivotably to said table body, pivotable relative to said table body between at least one viewing position and a storage position, and operable to display a gaming screen thereon; and
a positioning unit for positioning releasably said display device at the viewing position relative to said table body.

2. The gaming table as claimed in claim 1, wherein said table body includes a table top that has a longitudinal edge, said gaming table further comprising at least one personal display unit disposed on said table top adjacent to said longitudinal edge for viewing by an individual player.

3. The gaming table as claimed in claim 1, wherein:
said table body includes a leg portion and a table top that is disposed on said leg portion and that has a longitudinal edge, said table body being formed with a recess that is located in an intermediate section of said longitudinal edge of said table top and that extends into said leg portion, said leg portion having a pair of opposing inner walls which define opposite sides of said recess and which have upper portions, said upper portions of said inner walls being formed with aligned pivot holes, respectively, and said upper portion of at least one of said inner walls being formed with a plurality of positioning holes arranged in an arc that has a curvature center at said pivot hole;
said display device having opposite side edges, each of which has a lower portion provided with a pivot shaft for engaging pivotably said pivot hole in an adjacent one of said inner walls of said leg portion of said table body; and
said positioning unit includes at least one positioning implement between said display device and said table body, said positioning implement including a positioning arm having a mounting end mounted to said display device and a positioning end formed with a fastener hole, said positioning arm being movable with said display device to align said fastener hole with a selected one of said positioning holes in said table body, said positioning implement further including a fastening component that extends removably through said fastener hole and into the selected one of said positioning holes to position said display device at the viewing position.

4. The gaming table as claimed in claim 3, wherein said fastening component is a pin.

5. The gaming table as claimed in claim 3, wherein said positioning arm is mounted to said display device in such a manner that when said positioning arm is substantially parallel to said table top, said display device is at an optimum one of the viewing positions.

6. The gaming table as claimed in claim 3, wherein said positioning arm extends rearwardly from a lower portion of said display device.

7. The gaming table as claimed in claim 3, wherein said display device extends downwardly into said recess when at the storage position.

8. The gaming table as claimed in claim 7, wherein said leg portion of said table body has a raised stop platform that extends upwardly and that is disposed adjacent to a bottom part of said recess, a distance between a top surface of said stop platform and a table surface of said table top being slightly smaller that a height of said display device.

9. The gaming table as claimed in claim 3, wherein said display device extends into said recess and is flush with said table top when at the storage position.
